(19) United States
(12) Patent Application Publication
(10) Pub. No.: US 2013/0246113 A1
(43) Pub. Date: Sep. 19, 2013

(54) PROJECT MANAGEMENT AND MEASURING PERFORMANCE USING DELIVERABLES

(71) Applicants: Rupa Mantravadi, Redmond, WA (US); Sunil Garg, Issaquah, WA (US); Ramesh Gururaja, Sammamish, WA (US); Jeff D. Comstock, Mercer Island, WA (US); Julianne Prekaski, Seattle, WA (US); Brian L. Welcker, Seattle, WA (US)

(72) Inventors: Rupa Mantravadi, Redmond, WA (US); Sunil Garg, Issaquah, WA (US); Ramesh Gururaja, Sammamish, WA (US); Jeff D. Comstock, Mercer Island, WA (US); Julianne Prekaski, Seattle, WA (US); Brian L. Welcker, Seattle, WA (US)

(73) Assignee: Microsoft Corporation, Redmond, WA (US)

(21) Appl. No.: 13/563,733

(22) Filed: Aug. 1, 2012

Related U.S. Application Data
(60) Provisional application No. 61/612,002, filed on Mar. 16, 2012.

(51) Int. Cl. G06Q 10/06

(52) U.S. Cl. 705/7.15

(57) ABSTRACT

A deliverable is defined in terms presented for customer approval of a project. Tasks to be performed on the project are mapped to the deliverables so performance metrics and progress reports can be generated on a per-deliverable basis.

The present application is based on and claims the benefit of U.S. provisional patent application Ser. No. 61/612,002, filed Mar. 16, 2012, the content of which is hereby incorporated by reference in its entirety.

### BACKGROUND

In the manufacturing sector, there is a differentiation between built-to-stock items (which are often mass produced) and custom items (which are made to order). For example, on one computer manufacturer's website, a customer can choose a computer with a standard configuration, off-the-shelf and ready to ship, or the customer can define the specifications for a new computer that will be built for them, feature-by-feature. By way of example, the customer can specify which hard drive is to be used in the computer, how much random access memory (RAM) is to be provided in the computer, which graphics card to use, etc. There are some software systems that support both of these types of manufacturing scenarios.

This is not true, however, for the project-based industry. For instance, assume a project-based company is a software services company. Such a company employs resources who specialize in different areas of technology, such as developers, testers, designers, project managers, architects, database administrators, etc. The company uses the collective expertise of these resources in order to provide a wide variety of services to its customers.

In order to determine what is actually to be provided to the customer, the individual customer and the company often attempt to articulate a deliverable. That is, the individual customer articulates his or her needs and the company responds to those needs to define what will be delivered to the customer. The deliverable is often described in the language that is used by the customer, and it is something to which the customer can assign value. The customer contracts with the service provider to receive that deliverable for a given price and at a given time. In turn, the service provider (or company) manages its resources to produce this deliverable for the customer. The company designs the deliverable, and the deliverable design is a bridge between what the customer needs and how those needs are delivered by the service provider. It is the deliverable, and not the design, for which the customer often signs a contract. That is, the deliverable is a solution to a problem or the fulfillment of a need, and not the individual components (such as designs, specifications, test cases, documentation and worker hours) that go into making the deliverable.

In the project-based industry (such as in the software services industry), customers often have unique needs. Deliverables must normally be specifically crafted to the needs of the individual customer. In this context, the company often does not know in advance what deliverable the next customer will need. As a result there are generally no off-the-shelf enterprise resource planning (ERP) or other business software solutions in the service industries. Similarly, there is often no menu of components that a customer can choose from (such as 20 hours of design time, 70 hours of coding time, 14 test cases, etc.).

In addition, current project management software solutions focus on the definition, planning, resourcing and progress reporting of the work to be performed by an organization. This work definition (or work plan) is often in a form of a hierarchical task structure that is sometimes referred to as a work breakdown structure (WBS). Often, the way the work is defined for internal project execution is expressed in different terms and in a different form than what has been committed to the customer. Hence, it is often expressed in different terms than what is subsequently invoiced. The customer commitment (i.e., the deliverable) is usually captured in unrelated documents such as within a quote, a contract, a proposal, etc. This disconnect between the domain of project management solutions and an organization's commitment to its customer can make it challenging for project-driven organizations (such as computer service companies) to plan their work and monitor it in a way that enables them to deliver on their commitments successfully. That is, it can be difficult to know precisely when a deliverable has been met, and when it can be invoiced, and it can also be difficult to manage things based on the definition of the deliverables. Because the work plan, that is designed to generate the deliverables, is separate from the definition of the deliverables shown to the customer. It can also hinder the organization's ability to adapt to changes either by the customer or by the organization.

Further, current project management software solutions often analyze profitability and earned value for an entire project or for individual tasks within a project's WBS. However, the project's task structure (e.g., the WBS) is usually the way a project is managed and executed internally. A project's external commitments to its customers may vary from how the work is decomposed and managed internally. Since the external commitments of a project determine how the project is invoiced, and its revenue, current systems make it very difficult, if not impossible, to analyze the progress, profitability and earned value based on these external commitments.

The discussion above is merely provided for general background information and is not intended to be used as an aid in determining the scope of the claimed subject matter.

### SUMMARY

A deliverable is defined in terms presented for customer approval of a project. Tasks to be performed on the project are mapped to the deliverables so performance metrics and progress reports can be generated on a per-deliverable basis.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one illustrative project management system.

FIG. 2 is a flow diagram illustrating one embodiment of the overall operation of the system shown in FIG. 1.

FIGS. 2A-E are illustrative user interface displays.

FIG. 3 is a flow diagram illustrating one embodiment of the operation of the system shown in FIG. 1 in generating a plan and mapping it to a definition of deliverables.

FIG. 3A shows one embodiment of an illustrative user interface display in which tasks from a plan are mapped to deliverables.

FIG. 4 is a flow diagram illustrating one embodiment of the operation of the system shown in FIG. 1 in measuring performance against deliverables.

FIGS. 4A-4C are illustrative user interface displays.

FIG. 5 shows one illustrative data model.

FIG. 6 illustrates one embodiment of the system shown in FIG. 1 in a cloud computing architecture.

FIGS. 7-11 illustrate various embodiments of mobile devices.

FIG. 12 shows one embodiment of an illustrative computing environment.

### DETAILED DESCRIPTION

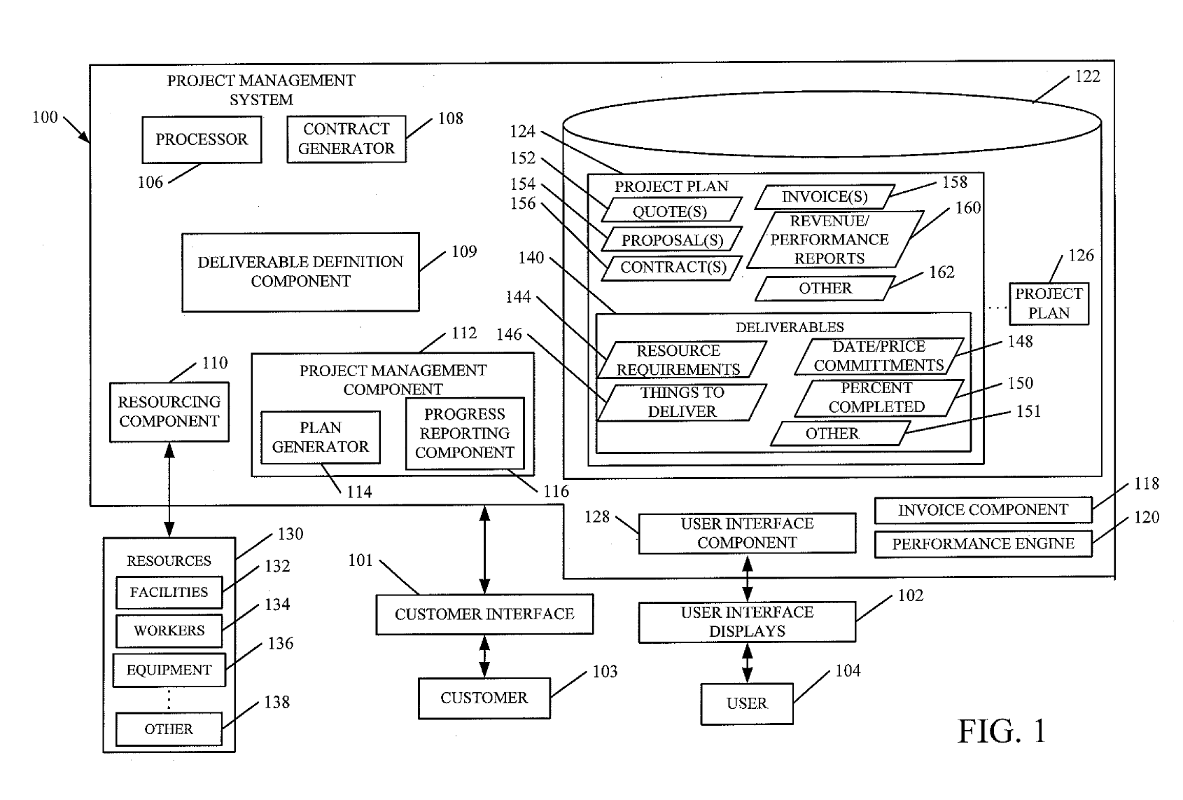

FIG. 1 is a block diagram of one illustrative project management system 100. FIG. 1 shows that system 100 generates user interface displays 102. In one embodiment, user interface displays 102 have user input mechanisms for receiving inputs from user 104 so that user 104 can interact with, and control, project management system 100. The user input mechanisms can be elements that the user allow to provide inputs using a point and click device, a keyboard, touch gestures, voice, etc.

FIG. 1 shows that project management system 100 includes processor 106, contract generator 108, deliverable definition component 109, resourcing component 110, project management component 112 (which, itself, includes plan generator 114 and progress reporting component 116), invoice component 118, performance engine 120, data store 122 (which stores a plurality of project plans 124 and 126), and user interface component 128. User interface component 128 is used by other components of system 100 to generate user interface displays 102.

FIG. 1 also shows that a customer 103 can illustratively provide communication with user 104 either directly (as indicated by arrow 105) or through system 100 using customer interface 101. Interface 101 can have input mechanisms that receive inputs from customer 103 for communicating with user 104.

In one embodiment, processor 106 is illustratively a computer processor with associated memory and timing circuitry (not shown). It is illustratively a functional part of system 100 and is activated by, and facilitates the functionality of, other components, generators and engines in system 100. Data store 122 is shown as part of system 100, but it can be separate from system 100 or located remotely from system 100, as well. In addition, data store 122 is shown as a single data store but it could be multiple data stores distributed in multiple locations as well.

FIG. 1 also shows that system 100 is illustratively connected to a source of resources 130 that can be assigned by resourcing component 110, to a given project plan. Resources 130 illustratively include facilities 132, workers 134, equipment 136 and other resources 138. FIG. 1 also illustrates that, in one embodiment, a project plan 124 illustratively includes the definition of a deliverable 140 that is defined by deliverable definition component 109. The deliverable can be defined in a number of ways, such as by specifying the resource requirements 144 that are needed to provide the deliverable, the specific things to deliver 146, the delivery date and price commitments 148, and a percent completed portion 150 that can be updated to shows the percentage of a given deliverable that has been completed during a project.

Before describing the operation of system 100 in more detail, a brief overview will be given. In one embodiment, user 104 interacts with system 100 through user interface displays 102 to control deliverable definition component 109 to define a deliverable. This can be done in conjunction with input from a customer. Definition of deliverables 140 can be put in a quote 152 or proposal 154. When one of these is accepted by the customer, the user can generate a contract 156 from the quote 152 or proposal 154. When the customer signs the contract 156, user 104 can use project management component 112 to generate a plan using plan generator 114. The plan generator 114 will divide the work required to deliver the deliverable into tasks and subtasks. User 104 can then use resourcing component 110 to assign resources 130 to those tasks and subtasks so that they can be completed. As they are completed, progress reporting component 116 can be used to manage the project and report the progress on a given project (such as on each deliverable in a project). When progress commitments are met and invoices can be generated, user 104 can generate invoices 158 using invoicing component 118. At various points during the progress of the plan 124 (or after it is completed), user 104 can use performance engine 120 to evaluate the performance of the company against the deliverables. Performance engine 128 can generate revenue/performance reports 160, or a variety of other performance indicators.

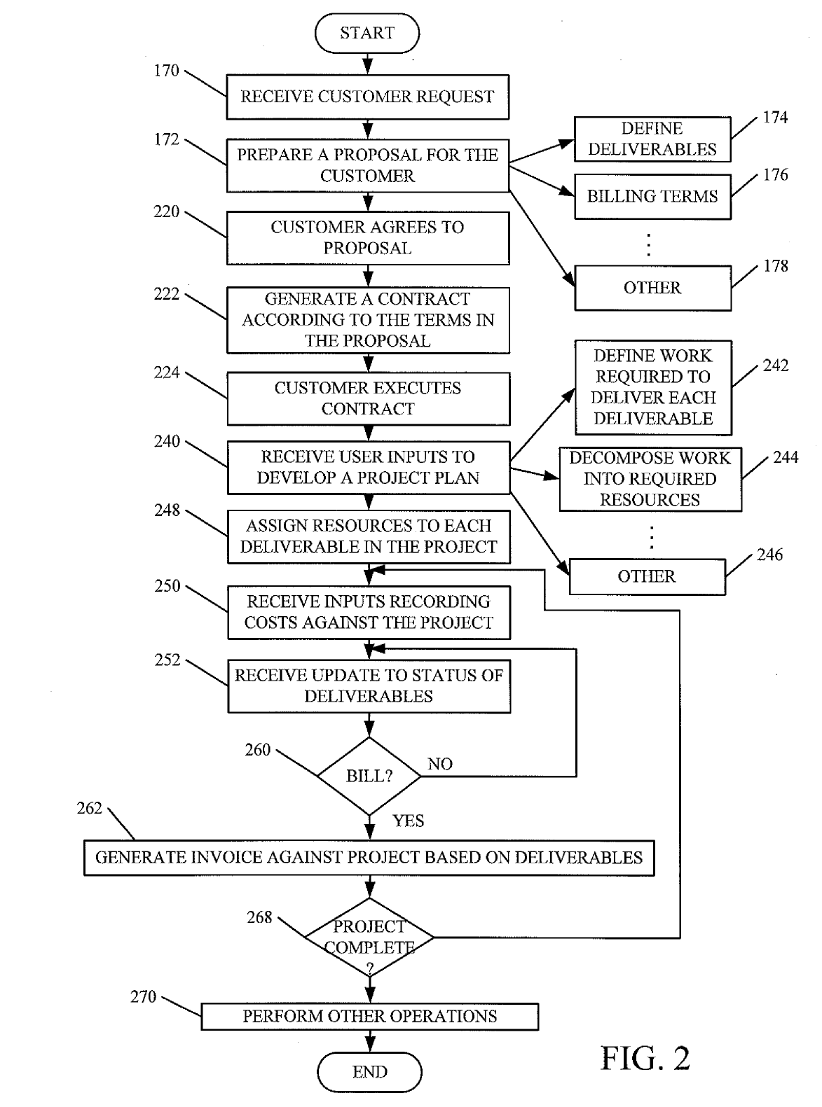

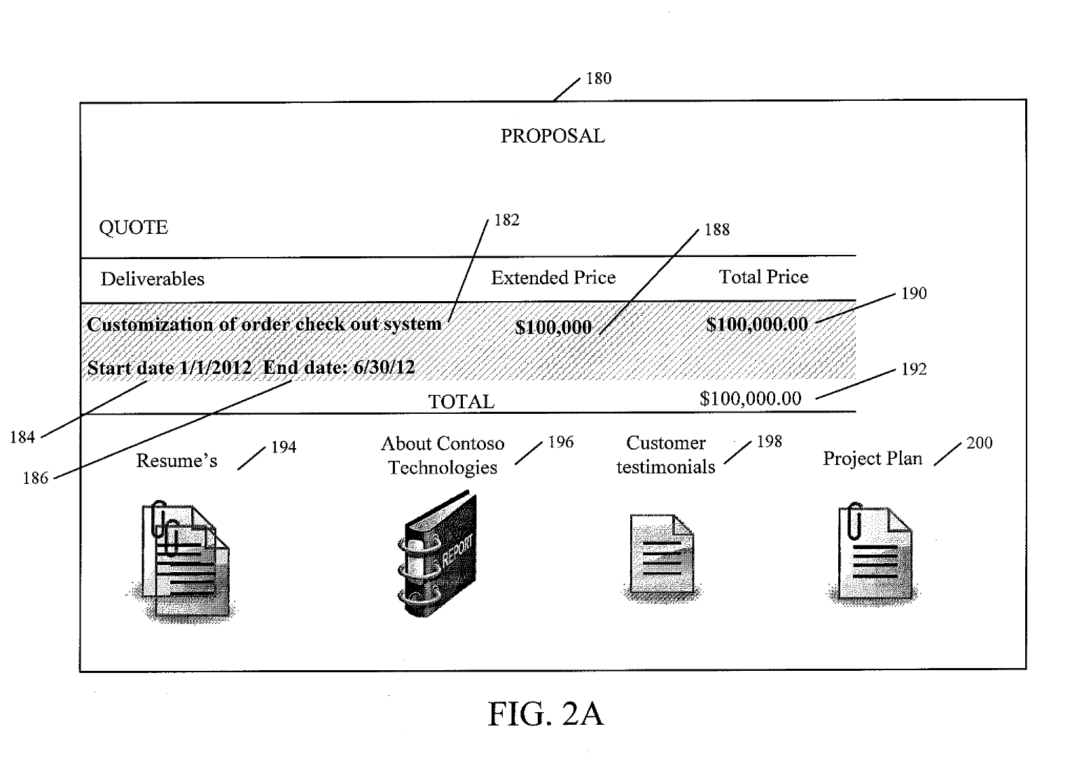

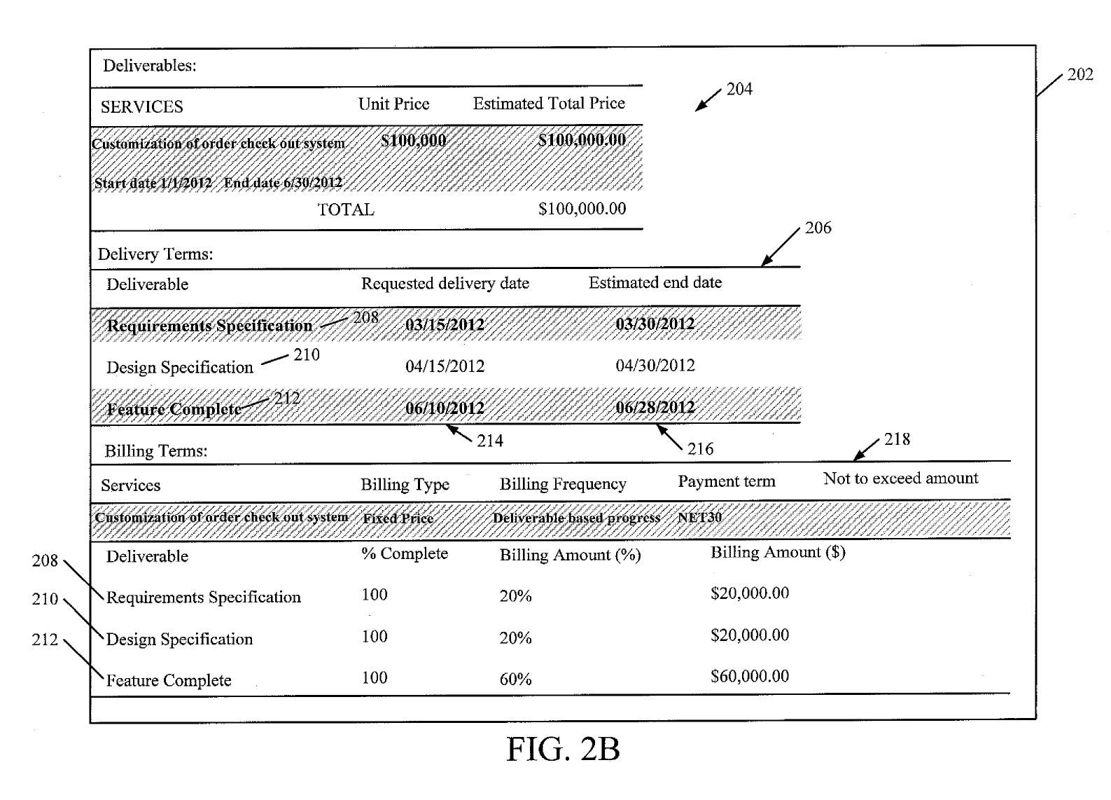

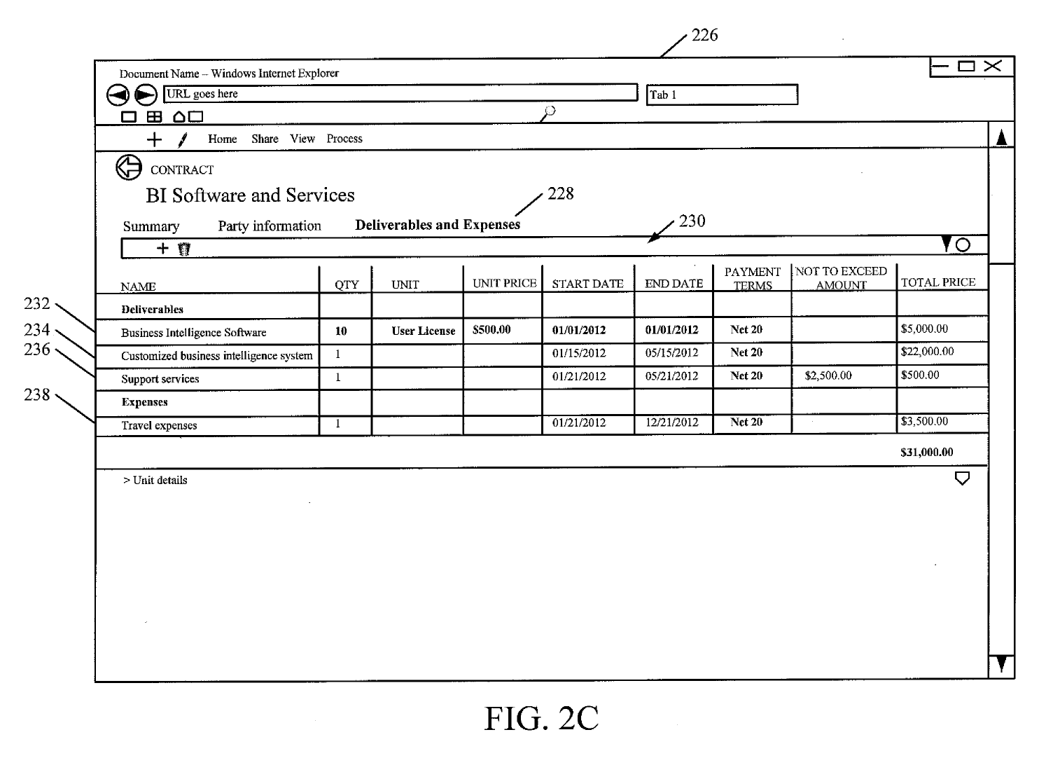

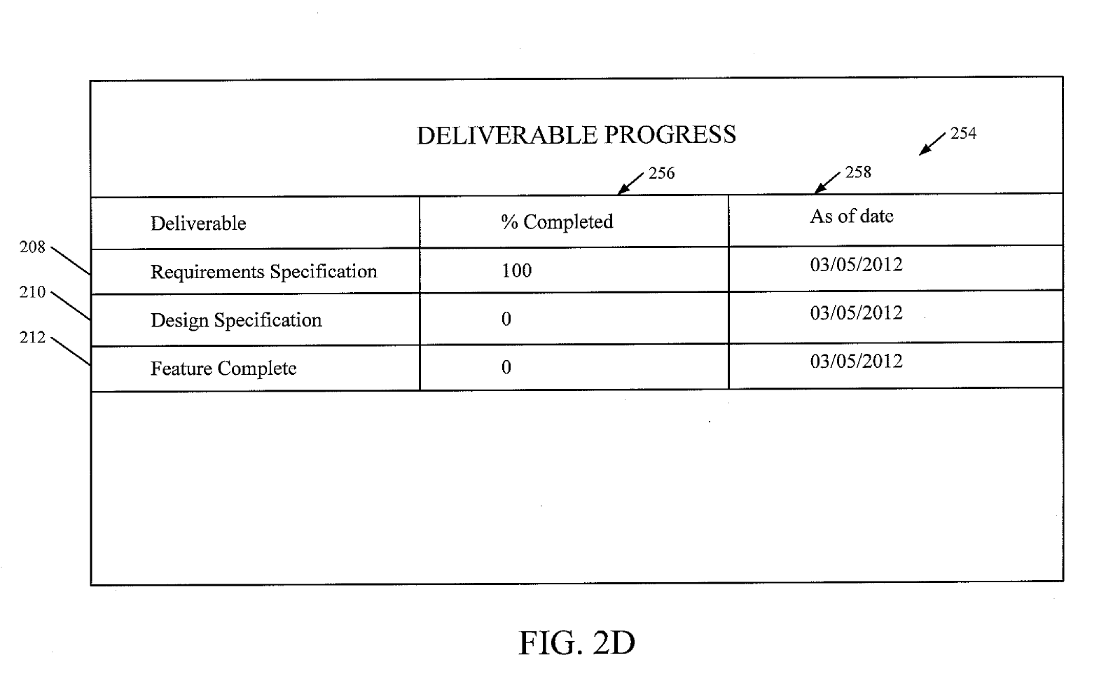

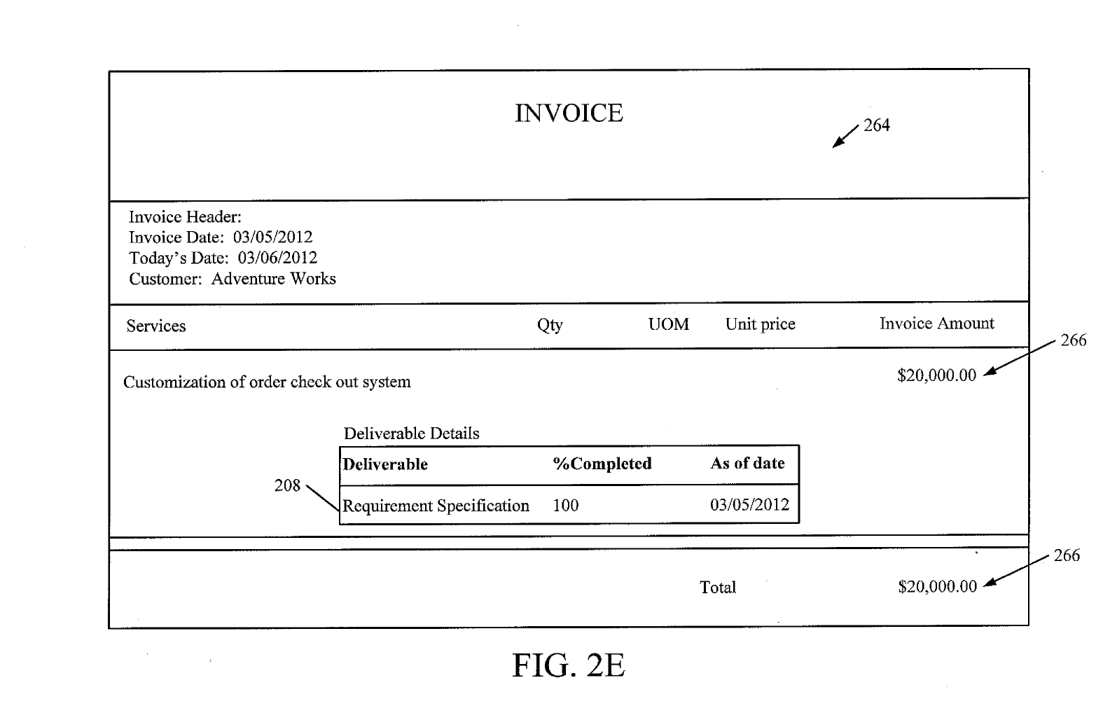

FIG. 2 is a flow diagram illustrating one embodiment of the operation of system 100 in more detail. FIG. 2 illustrates how system 100 can be used to define deliverables, design a project plan to deliver those deliverables, and manage that plan to completion and invoicing. System 100 first receives a customer request from customer 103, illustratively through customer interface 101. Of course, as discussed above, customer 103 can communicate with user 104 through a separate system as well, and those communications can be input into system 100 by user 104. However, for the sake of the present example, it will be assumed that customer 103 communicates with user 104 through system 100. Receiving the customer request is indicated by block 170 in FIG. 2.

In one embodiment, the request from the customer indicates a need that the user's company can fill by designing and performing a project to deliver deliverables to the user. Therefore, in response to receiving the request, user 104 uses system 100 to prepare a quote or proposal (152 or 154, respectively) for customer 103. This is indicated by block 172. In generating the proposal, user 104 illustratively interacts with customer 103 to define the specific deliverables 140 that the customer needs. Defining the deliverables is indicated by block 174 in FIG. 2. User 104 will illustratively include, in the definition of the deliverables, billing terms which indicate when the user can bill the customer for work done against the project. This is indicated by block 176. Further, of course, other information can be included in the proposal as indicated by block 178.

FIG. 2A shows one illustrative embodiment of a user interface display 180 that represents a quote or a proposal. It can be seen that, in one embodiment, the deliverables are “customization of order checkout system” as indicated at 182. The proposal or quote also illustratively includes a start date at 184 and an end date at 186. The proposal also illustratively includes an extended price 188, a total price 190 and a total of all deliverables 192. In the embodiment shown, proposal 180 also illustratively includes links to resumes 194 for the workers, that are going to be performing on the deliverables, a link 196 to additional information about the company, a link 198 to customer testimonials and a link to the proposed project plan which is to be, or has been, designed to deliver the deliverables at 182. The proposed project plan link is indicated by numeral 200.

FIG. 2B illustrates a user interface display 202 that defines the deliverables in greater detail. In one embodiment, user interface display 202 is generated from user interface display 180 when the user actuates a button or link on display 180. Table 204 shows the same information that was disclosed in user interface display 180 in FIG. 2A. However, table 206 breaks the services for the project into three distinct deliverables. One is the development of a requirements specification 208, the next is a design specification 210 and the final is a feature complete deliverable 212 which corresponds to completion of the entire project. Each of the deliverables 208-212 has a requested delivery date shown in column 214 and an estimated end date shown in column 216. User interface display 208 also illustratively includes the billing terms table 218 that specifies when amounts can be billed against the project.

Once the customer 103 has reviewed the proposal, the customer can agree to the proposal. This is indicated by block 220 in FIG. 2. In response, user 104 can use contract generator 108 to generate a contract 156. Contract generator 108 imports the elements from the proposal shown in FIG. 2B into a contract, thereby filling out the various terms in the contract with the information shown in FIG. 2B. Generating a contract according to the terms in the proposal is indicated by block 222 in FIG. 2. The contract 156 can then be provided to customer 103 through customer interface 101, or in a different way, for execution by customer 103. Execution of the contract by the customer is indicated by block 224 in FIG. 2.

FIG. 2C shows another user interface display 226 which displays the deliverables and expenses in a portion of a different contract from that discussed above. In FIG. 2C, the deliverables and expenses are displayed when the user actuates deliverables and expenses button 228 on user interface display 226. This causes table 230 to be displayed. The particular deliverables shown in Table 230 are a business intelligence software license 232, customize billing intelligence system 234, support services 236, and travel expenses 238. It can be seen that table 230 also illustratively displays a quantity, unit, unit price, start date, end date, payment terms, not to exceed amount and total price for each of the deliverables 232-238.

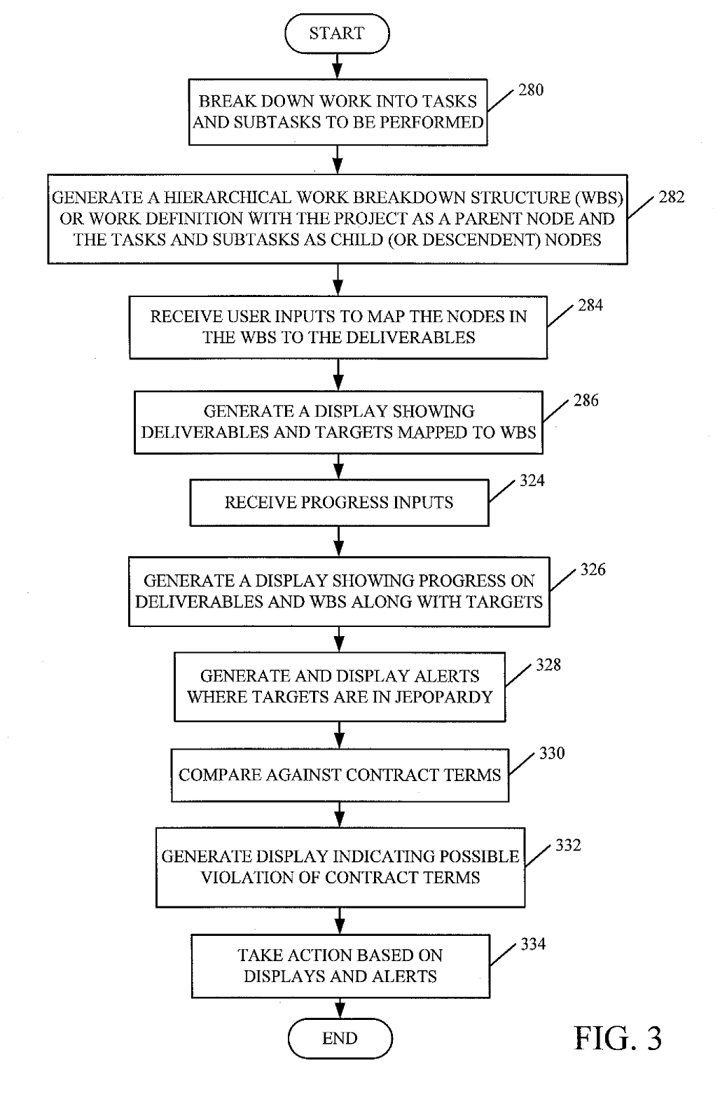

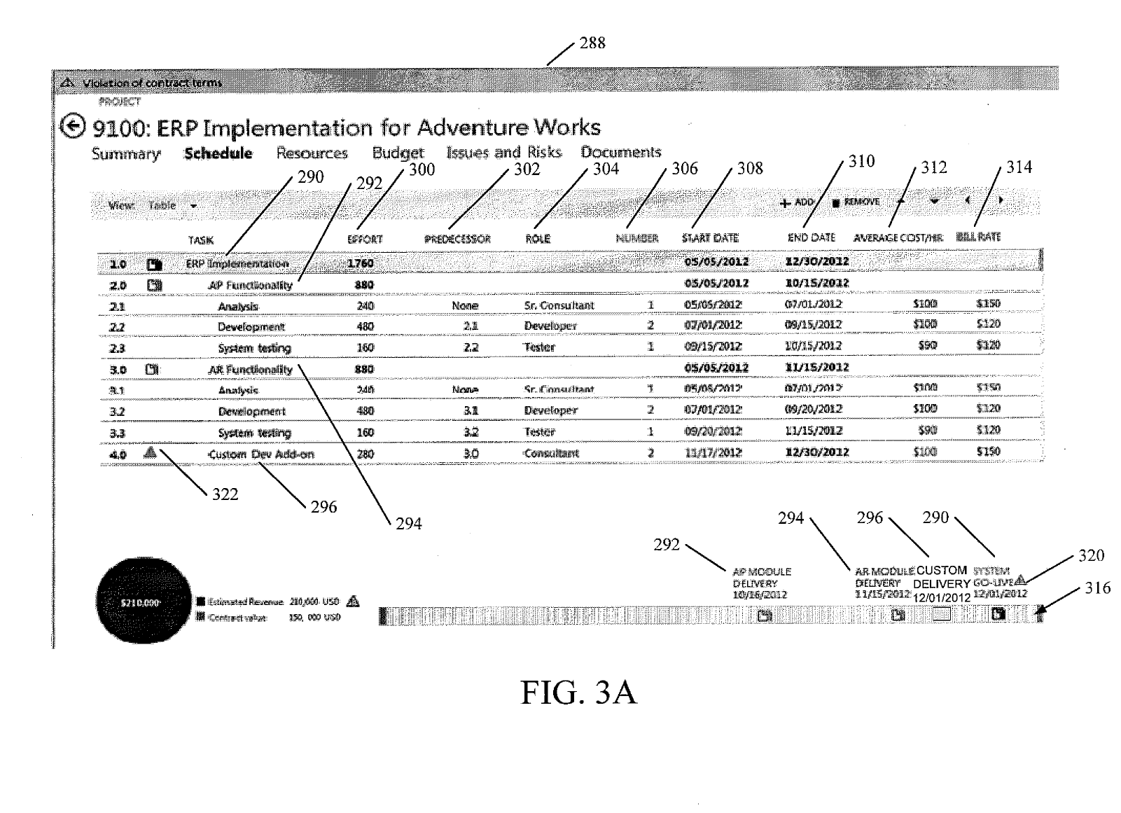

After the user has executed the contract, system 100 receives input from user 104 (and specifically plan generator 114 receives user inputs) to develop a project plan 124 by which the deliverables can be delivered to the customer 103. This is indicated by block 240 in FIG. 2. This is defined in greater detail below with respect to FIG. 3. Briefly, however, the user defines the work required to deliver each deliverable. This is indicated by block 242. The user then decomposes that work into required resources as indicated by block 244, and the user can perform other actions in developing the project plan as well. This is indicated by block 246.

Once the project plan has been generated, user 104 can use resourcing component 110 to actually assign resources to each deliverable in the project plan. This is indicated by block 248 in FIG. 2. Recall that, at block 244, the user identified resources required for each deliverable, and the user actually assigns those resources to each deliverable at block 248. This can be done in a wide variety of ways. In one embodiment, resourcing component 110 can generate a user interface display through which the user can view all available resources and assign those resources based on the dates that they are available, to a given project plan. This can be done using drag and drop functionality. For instance, the user can drag available resources from one pane to tasks or subtasks in the project plan in another pane. Of course, assigning resources can be done in any other desired way as well. In any case, user 104 illustratively assigns facilities 132, workers 134, equipment 136, or any other resources 138 to each deliverable in order to have the deliverable completed within a desired time.

Once the project plan 124 is completed, user 104 can use project management component 112 (and specifically progress reporting component 116) to manage the project and update the progress made toward delivering each deliverable. Invoice component 118 can also receive user inputs recording costs against the project. This is indicated by block 250 in FIG. 2. Receiving the inputs recording costs can simply be user 104 entering timesheet entries against the various deliverables in project plan 124, it can be entering travel expenses or other expenses, or it can be entering substantially any other costs against the project. User 104 can also use progress reporting component 116 to update the progress or status of each of the deliverables. This is indicated by block 252.

FIG. 2D shows one example of an illustrative user interface display 254 that allows user 104 to update the progress of each deliverable. It can be seen that user interface display 254 displays the same deliverables 208-212, which are shown in the user interface display of FIG. 2B. User interface display 254 provides a percent completed column 256 which allows the user to select one of the cells in column 256 and update the percent completed. User interface display 254 also includes a date column 258 that allows user 104 to update the date that the percent completed number was actually completed.

Recall that the contract executed by the user and the customer will illustratively define the billing terms that specify when user 104 can invoice customer 103. In the embodiment shown in FIG. 2B, for instance, table 218 indicates that user 104 can invoice 20 percent of the contract amount when deliverable 208 is completed, and another 20 percent when deliverable 210 is completed and the last 60 percent when deliverable 212 is completed.

In one embodiment, invoice component 118 compares the invoice terms in the contract against the progress reported by progress reporting component 116 to determine whether a bill or invoice can now be generated. That is, invoice component 118 determines whether the criteria for sending an invoice have been met, based on the terms of the contract. Making this determination is indicated by block 260 in FIG. 2.

If the criteria for sending an invoice have not yet been met, the system simply waits until the progress has been updated sufficiently that an invoice can be generated. However, if an invoice can be generated, then invoice component 118 illustratively generates an invoice as indicated by block 262. FIG. 2E is one illustrative user interface display 264 that shows one invoice that can be generated by invoice component 118. It can be seen that the invoice generated includes a total of $20,000 (which is 20 percent of the contract amount) because the first deliverable 208 has been 100 percent completed. The invoice amount is indicated generally at 266 in FIG. 2E.

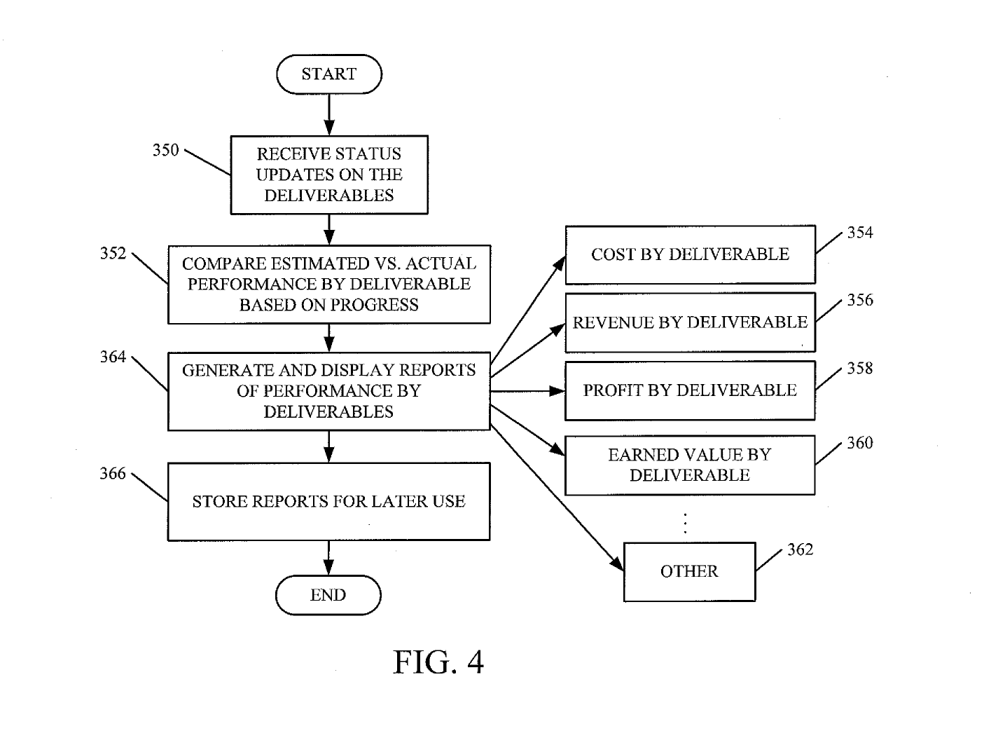

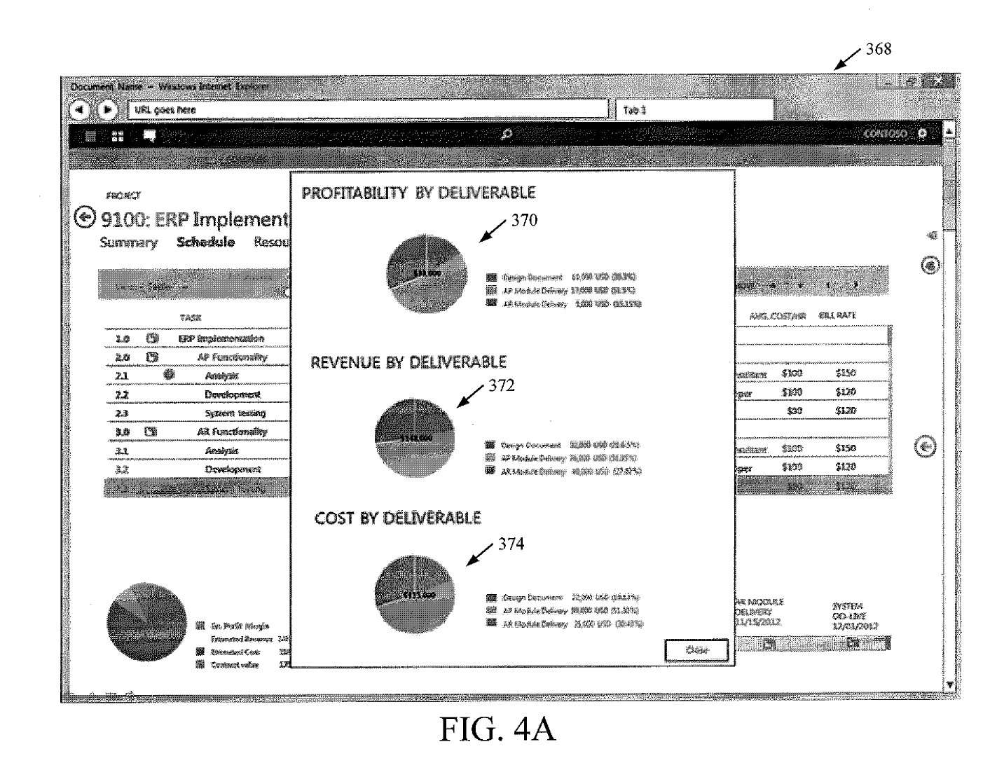

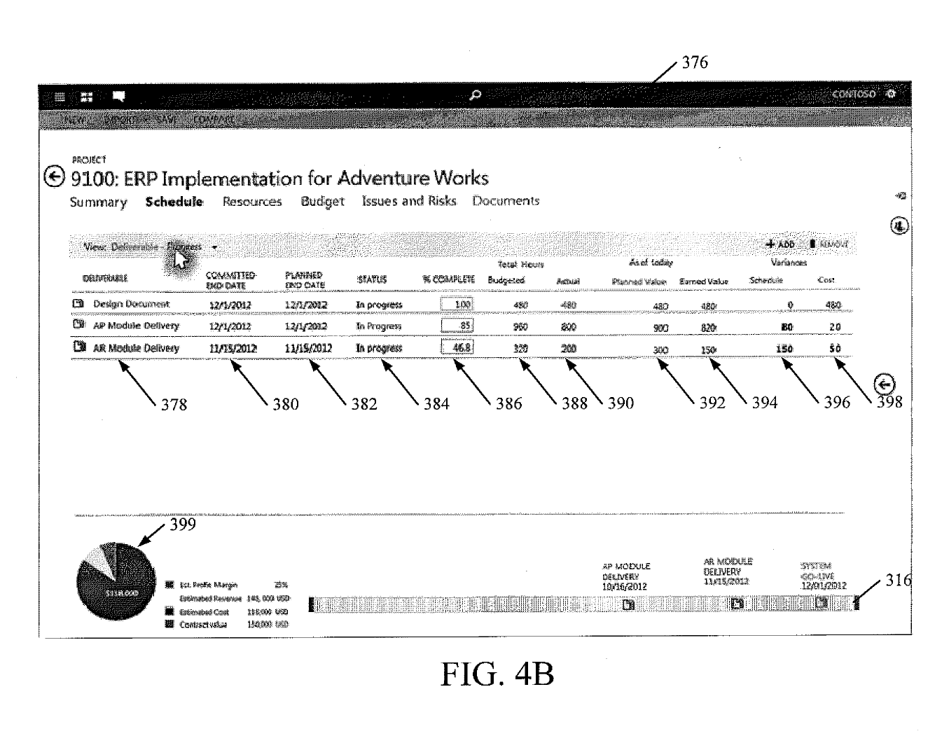

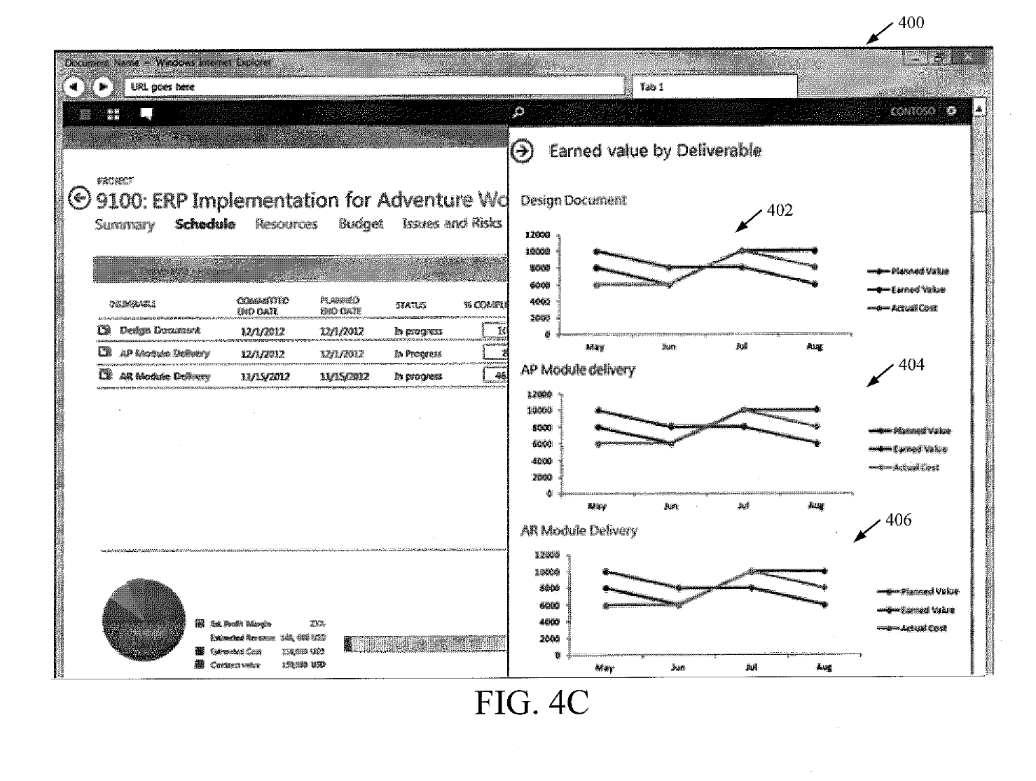

Project management component 112 then determines whether the project is complete. If so, and all of the invoices have been sent and paid, then additional processing can be performed as indicated by block 270. Such processing can include measuring performance against the deliverables using performance engine 120 described in greater detail below with respect to FIG. 4. Other processing can be performed as well. When that is complete, processing can terminate with respect to this project plan 124. Determining whether the project is complete is indicated by block 268 in FIG. 2.

If the project has not been completed, and all invoices have not yet been generated and paid, then processing can revert back to block 250 where additional costs are recorded against the project and status of deliverables is updated and additional invoices are generated.

FIG. 3 is one embodiment of a flow diagram illustrating how system 100 operates to generate project plan 124 (as indicated by block 240 in FIG. 2), in more detail. In one embodiment, user 104 first uses plan generator 114 to breakdown the work that needs to be performed into tasks and subtasks. This is indicated by block 280 in FIG. 3. User 104 then uses plan generator 114 to generate a hierarchical work breakdown structure (WBS) or another type of work definition. In this type of hierarchical structure, the entire project is a parent node and the tasks and subtasks are child (or grandchild or other descendent) nodes. Generating this hierarchical structure is indicated by block 282 in FIG. 3.

It should be noted that the hierarchical structure can be generated in a variety of different ways. For instance, plan generator 114 can generate a user interface display 102 that has a set of tasks in one pane and the hierarchical structure in another pane. The user can drag tasks and subtasks from one pane to the other, and place them as nodes in the hierarchical structure. Of course, other ways of generating the hierarchical work breakdown structure (or other work definition) are contemplated herein as well.

Once the work breakdown structure (or work definition) has been generated, user 104 can use plan generator 114 to provide user inputs that map the nodes in the WBS (or work definition) to the deliverables. This is indicated by block 284 in FIG. 3. This can be done in a variety of different ways as well. For instance, in one embodiment, the WBS that defines the work to be performed on a given project is displayed in one pane, and another pane shows the various deliverables. The user can use drag and drop functionality to cause various tasks or subtasks on the WBS to feed into one or more of the deliverables. This will indicate which tasks or subtasks in the WBS need to be performed in order to complete a deliverable. Once the mapping is performed, plan generator 114 illustratively generates a user interface display showing the deliverables and the various targets (such as completion dates, expense targets, etc.) from the contract mapped to the WBS (or other work definition). This is indicated by block 286 in FIG. 3.

FIG. 3A shows one illustrative user interface display 288 that shows a set of tasks mapped to a set of deliverables. The project shown in user interface display 288 of FIG. 3A is an ERP implementation 290. Therefore, in one embodiment, the user has associated the root node in the WBS (or other work definition) with the entire “ERP implementation” project 290. Also, in one embodiment, the deliverables defined by user 104 and customer 103 (that must be performed in order to complete the ERP implementation 290) are to deliver AP functionality 292, AR functionality 294 and a custom development add-on 296. Deliverables 292 and 294 each have a plurality of tasks that must be performed to deliver the corresponding deliverable. Each of the tasks 2.1, 2.2 and 2.3 (which are numbers that identify these tasks on the WBS or work definition) feed into the AP functionality deliverable 294. That is, tasks 2.1, 2.2 and 2.3 must all be completed for the AP functionality 292 to be delivered. Similarly, tasks 3.1, 3.2 and 3.3 (which are numbers that identify these tasks on the WBS or work definition) must all be formed in order to deliver the AR functionality 294. Therefore, the table in user interface display 288 shows which tasks have been mapped to which specific deliverables.

FIG. 3A also shows that user interface display 288 has an effort column 300, predecessor column 302, role column 304, number column 306, start date column 308, end date column 310, average cost per hour column 312 and bill rate column 314. Of course, these columns are exemplary only and other columns, additional columns, or different columns could be used as well. The effort column 300, in the embodiment shown in FIG. 3A, shows the total number of effort units (in this case, hours) that will be required for the entire project 290 and for each of the tasks in each deliverable 292, 294 and 296. The predecessor column 302 indicates which tasks must be completed before other tasks. That is, predecessor column 302 shows that the analysis task 2.1 is a predecessor to the development task 2.2. Therefore, the analysis task 2.1 must be completed prior to completion of (or the beginning of) the development task 2.2. Of course, this is given by way of example as well.

Role column 304 indicates the particular role of a worker that is to perform the corresponding task. For instance, the analysis task 2.1 is to be performed by a senior consultant.

Number column 306 indicates the number of workers required to perform the task. Thus, only one senior consultant is required to complete the analysis task 2.1.

The start and end date columns 308 and 310, respectively, indicate the expected start and end dates for the project as a whole, and for each task in each deliverable. These dates are updated based on progress inputs by user 104, or any of the other people who provide inputs to update the status of a given task, subtask, deliverable, or the project as a whole. As users inputs progress updates, the start date of a successor task may be moved based on the estimated completion date of a predecessor task. Similarly, the end date of any task, subtask, deliverable, or even the project as a whole, can be updated based upon the various progress inputs on any of the tasks that need to be completed and based upon the order of succession in which they need to be completed. For instance, if the end date of analysis task 2.1 is pushed out by a week, that means that the start date of development task 2.2 may need to be pushed by a week, and the end date of development task 2.2 may need to be pushed out by a week as well. The same is true of system testing task 2.3, because it has development task 2.2 as a predecessor. If that occurred, this, of course, would change the end date of the AP functionality deliverable 292 as well, because that end date is based upon the end dates of all of the tasks that flow into deliverable 292. It may also change the dates for other deliverables that have deliverable 292 (or a portion of it) as a predecessor, and it may change the dates for the entire project 290, as a whole.

Columns 312 and 314 display the average cost per hour and the billing rate for each of the tasks in each of the deliverables.

In one embodiment, where target dates or target costs or expenses are in jeopardy (that is, where the target dates or target costs or expenses may be exceeded), project management component 112 illustratively highlights them on user interface display 288, or another similar user interface display. This will give the project manager a chance to identify certain tasks, subtasks, or deliverables that may be problematic. It should be noted that, in some embodiments, a given date or cost estimate on a task, subtasks or deliverables might be exceeded without necessarily violating or contract term. However, where progress updates indicate that contract terms may be violated, these can be illustrated as well. In one embodiment, for instance, once the progress updates are received (such as cost updates, percent completion updates, etc.) progress reporting component 116 compares the estimated end dates, the delivery dates of the various deliverables and the project as a whole, and the estimated costs, against those identified in the contract to identify possible violations of the contract.

User interface display 288 also includes a timeline 316 that plots the deliverables 292, 294 and 296, along with their delivery dates (plotted on timeline 316). Timeline 316 also has the delivery date for the entire project 290 plotted on it as well. The deliverables and the delivery dates for the deliverables, on timeline 316, are obtained from the contract. Therefore, the delivery dates for the deliverables on timeline 316 are the delivery dates that are expected by the customer, based upon the executed contract. It can be seen from the table in user interface display 288 that the customized add-on deliverable 296 now has an end date which has been updated to Dec. 30, 2012. That means that the entire project 290 cannot be completed until Des. 30, 2012. However, timeline 316 shows that it should be completed on Dec. 1, 2012, based on the terms in the contract which was executed by the customer.

Therefore, project management component 112 illustratively identifies that, given the current progress on project 290, the company is not going to meet the delivery date for the project. Project reporting component 116 then generates an alert on user interface display 288. The alert can take one of a variety of different forms. In the embodiment shown in FIG. 3A, component 116 generates an exclamation point and alert marker 320 on timeline 316. This is because the delivery date for the entire project is set in the contract at Dec. 1, 2012, but the estimated end date in column 310 is now Dec. 30, 2012. Component 116 also illustratively generates a warning marker 322 next to the deliverable, task or subtask which is causing the problem. Of course, there may be one or more tasks or deliverables which are behind schedule, in which case a warning marker can be generated and displayed next to each one.

While the warning markers shown in FIG. 3A are exemplary only, it should be noted that others could be used as well. For instance, the task or deliverable that is behind schedule may be displayed in bold, in red or another color, or visually distinguished from the remainder of user interface display 288 in another way. Receiving progress inputs against the various tasks and deliverables in the project is indicated by block 324 in FIG. 2, generating a display showing progress of deliverables, and the tasks in the WBS, along with targets, is indicated by block 326 in FIG. 3, and generating and displaying alerts where targets are in jeopardy is indicated by block 328.

Comparing the terms against the contract to identify possible contract violations is indicated by block 330 in FIG. 3, and generating a display indicating possible violation of contract terms is indicated by block 332.

Being aware of possible contract violations, the project manager can now better manage expectations with the customer. For instance, the project manager can communicate with the customer requesting a revision to the contract (such as the price, the delivery dates, or other terms of the contract) based upon the information displayed. Of course, the project manager can take other actions based on that information as well. For instance, the project manager may deploy more resources on completing a task that is behind schedule. Because the tasks in the work definition are now tied to the deliverables expected by the customer, the project manager is better able to efficiently deploy resources to make sure the deliverables are delivered in a timely and cost efficient way. This also allows the project manager to more easily meet the expectations of the customer. Taking action based upon the displays and alerts is indicated by block 334 in FIG. 3.

As discussed above briefly with respect to FIGS. 1 and 2, performance engine 120 can be used to evaluate the performance of the company with respect to various deliverables. For instance, performance engine 120 can calculate the percent of overall profit contributed to each deliverable, the percent of the schedule and budget variances contributed to each deliverable, and earned value, shown by deliverable. Performance engine 120 can be invoked either during performance of the project, or once the project is completed. This allows the project manager, or other user, to better understand the overall profitability and earned value metrics (or any other desired performance metrics) of the project, based on the particular deliverables delivered to the customer. FIG. 4 is a flow diagram illustrating one embodiment of the operation of performance engine 120 and system 100, in evaluating performance on a per-deliverable basis.

Progress reporting component 116 in project management component 112 receives various status updates on the deliverables, as discussed above. This is indicated by block 350 in FIG. 4. Performance engine 120 then compares the estimated, versus actual, performance, by deliverable, based upon the progress inputs. Again, the progress inputs can be costs or expenses billed against the various deliverables, percent completion of the various deliverables, or other progress metrics. In order to compare these actual values against estimated values, performance engine 120 illustratively accesses the contract 156 and other estimated values used as performance metrics, that may be stored in data store 122. Comparing the estimated against actual performance metrics is indicated by block 352 in FIG. 4.

Performance engine 120 can, for instance, compare estimated cost against actual costs of a deliverable as indicated by block 354, estimated against actual revenue by deliverable as indicated by block 356, estimated against actual profit by deliverable as indicated by block 358, earned value by deliverable as indicated by block 360, or any other performance metrics as indicated by block 362. Performance engine 120 then uses user interface component 128 to generate a user interface display that reports performance, by deliverable. This is indicated by block 364 in FIG. 4. Of course, the reports can be stored for later use as well. This is indicated by block 366.

FIG. 4A shows one illustrative user interface display 368 that displays profitability by deliverable, revenue by deliverable and costs by deliverable. It can be seen that each display is a pie chart. The profitability pie chart 370 takes the profitability for the entire project and attributes a portion of it to each of the deliverables. Revenue pie chart 372 does the same for revenue, and cost pie chart 274 does the same for costs.

Of course, performance engine 120 can also plot the variances between the estimated and actual performance metrics. FIG. 4B shows a user interface display 376 that displays, in tabular form, each deliverable in deliverable column 378, a committed end date in column 380, a planned end date in column 382, a status in column 384, a percent complete in column 386, budgeted and actual hours in columns 388 and 390, a planned earned value and an actual earned value in columns 392 and 394, respectively, and a variance in the schedule and cost columns 396 and 398, respectively.

The timeline 316 in FIG. 4B is also displayed, along with a pie chart 399. Pie chart 399 shows the value of the contract, the estimated cost for the contract, the estimated revenue for the contract, and the estimated profit margin for the contract. This is another way of showing performance metrics for a given project, as a whole.

FIG. 4C shows another user interface display 400 that has a plurality of x-y coordinate graphs. Graph 402 is generated for the design document deliverable, graph 404 is generated for the AP module deliverable and graph 406 is generated for the AR module deliverable. It can be seen that each graph plots time (in months) against earned value (in dollars).

It can thus be seen that FIGS. 4B and 4C show illustrative user interface displays that display earned value by deliverable, highlighting the negative and positive variances in tabular, and graphical form, respectively.

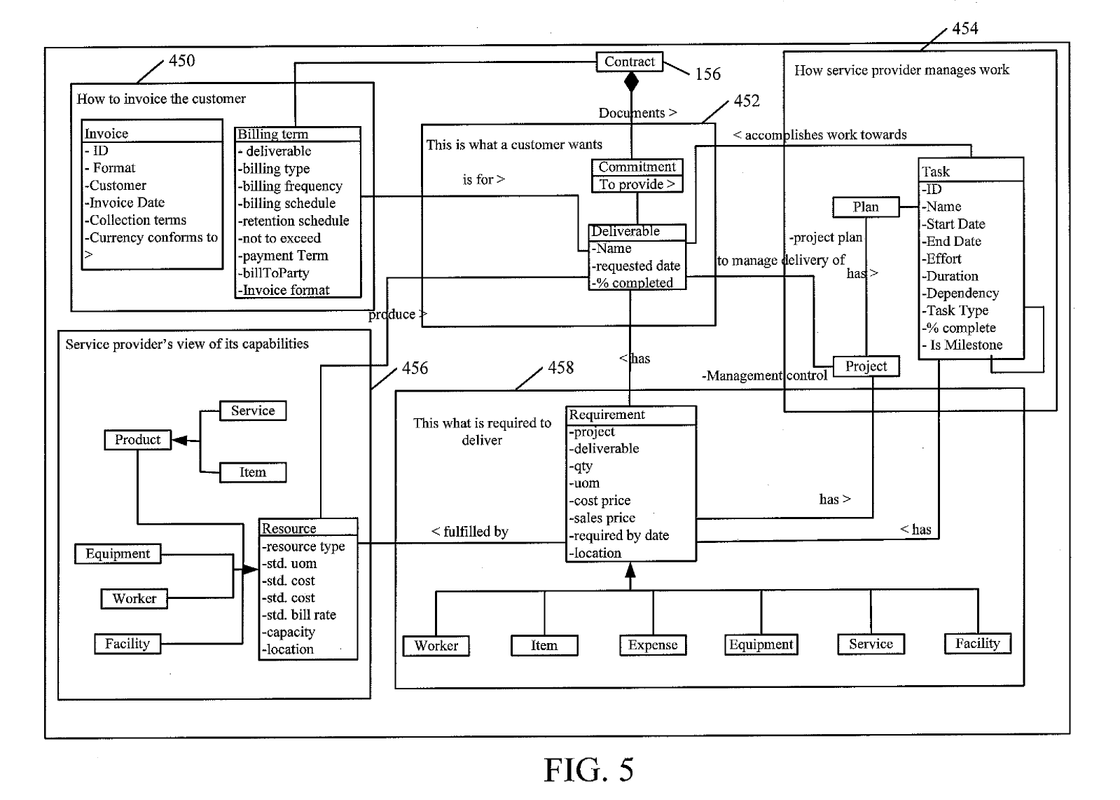

FIG. 5 shows one embodiment of a data model that can be used to implement system 100 shown in FIG. 1. The model in FIG. 5 is a UML diagram and it includes invoicing portion 450 that indicates how to invoice the customer. It also includes deliverables portion 452 that displays commitments and deliverables to the customer and provides them to contract 156. It includes a management portion 454 which indicates how the company is going to manage the work. It also includes resources portion 456 that allows the user or project manager to view the various resources at his or her disposal. Finally, it includes requirements portion 458 that shows the requirements that are needed to fulfill the contract 156.

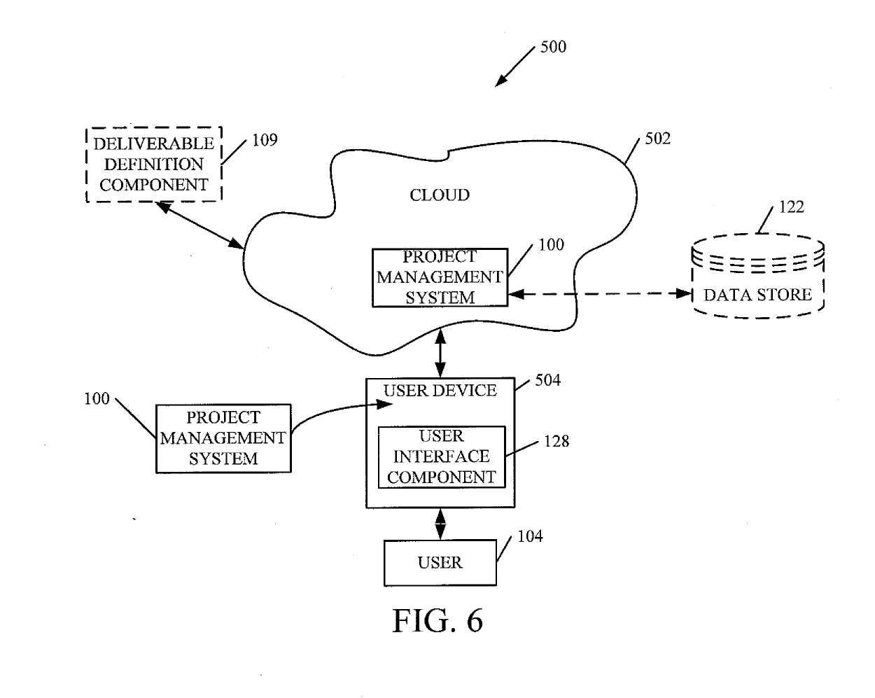

FIG. 6 is a block diagram of system 100, shown in FIG. 1, except that it is disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of system 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 6, some items are similar to those shown in FIG. 1 and they are similarly numbered. FIG. 6 specifically shows that system 100 is located in cloud 502 (which can be public, private, or a combination where portions are public while others are private). Therefore, user 104 uses a user device 504 to access those systems through cloud 502.

FIG. 6 also depicts another embodiment of a cloud architecture. FIG. 6 shows that it is also contemplated that some elements of business system 100 are disposed in cloud 502 while others are not. By way of example, data store 122 can be disposed outside of cloud 502, and accessed through cloud 502. In another embodiment, deliverable definition component 109 (for example) is also outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that system 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

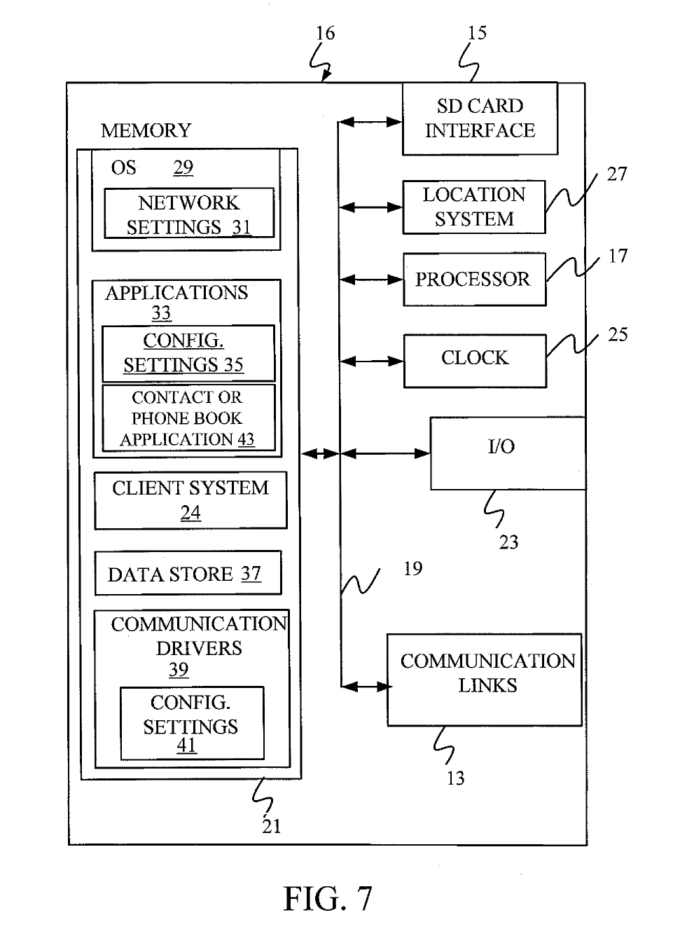

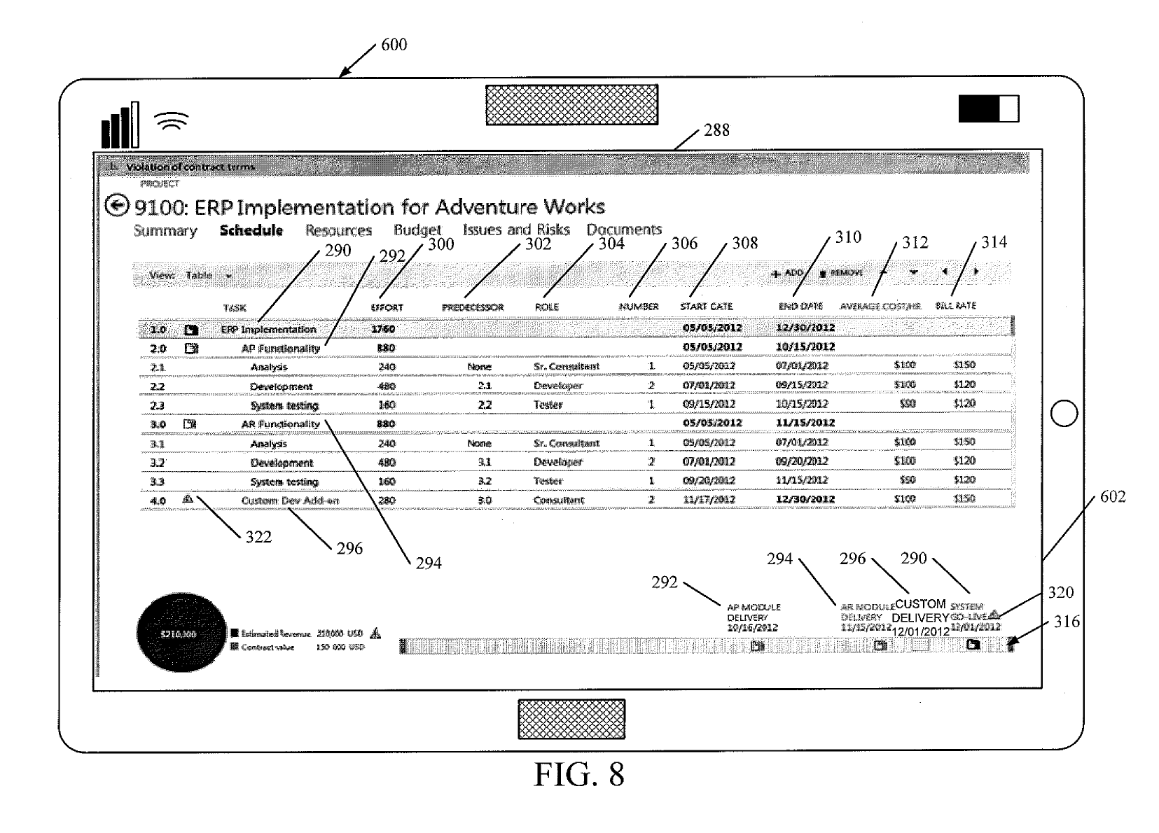

FIG. 7 is a simplified block diagram of one illustrative embodiment of a handheld or mobile computing device that can be used as a user's or client's hand held device 16, in which the present system (or parts of it) can be deployed. FIGS. 8-11 are examples of handheld or mobile devices.

FIG. 7 provides a general block diagram of the components of a client device 16 that can run components of system 100 or that interacts with system 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems (like system 100) are received on a removable Secure Digital (SD) card that is connected to a SD card interface 15. SD card interface 15 and communication links 13 communicate with a processor 17 (which can also embody processor 106 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. System 100 or the items in data store 122, for example, can reside in memory 21. Similarly, device 16 can have a client system 24 which can run various business applications or embody parts or all of system 100. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

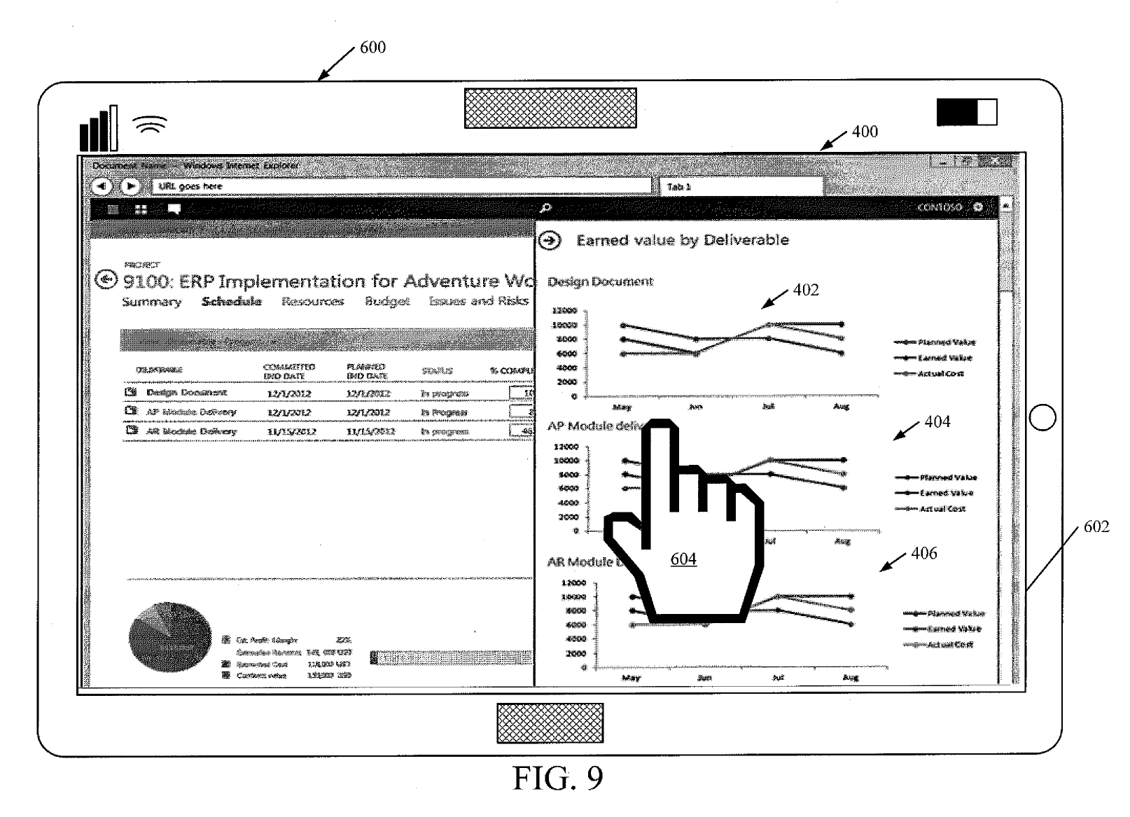

FIGS. 8 and 9 show one embodiment in which device 16 is a tablet computer 600. In FIG. 8, computer 600 is shown with user interface display 288 displayed on the display screen 602. FIG. 9 shows computer 600 with user interface display 400 (used to display performance on a per-deliverable basis) displayed on display screen 602. Screen 602 can be a touch screen (so touch gestures from a user's finger 604 can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

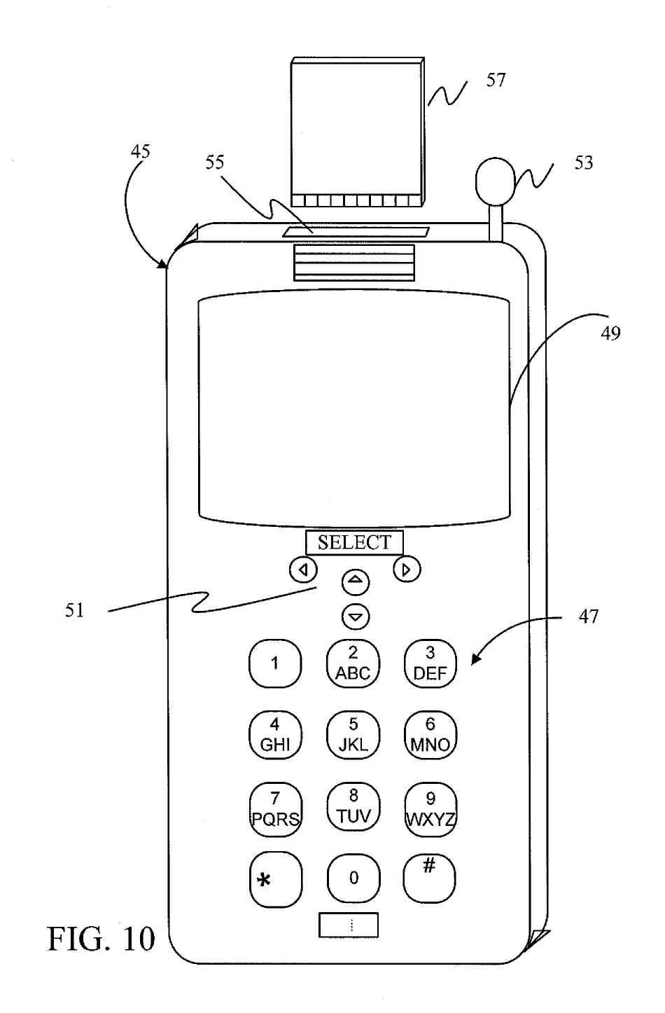

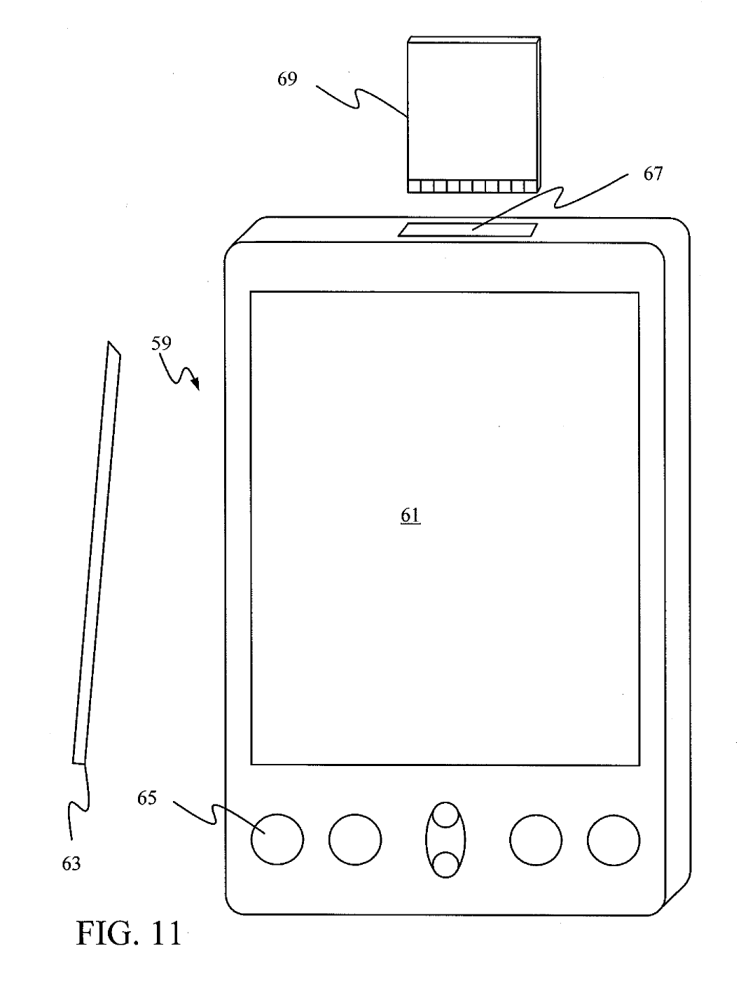

FIGS. 10 and 11 provide additional examples of devices 16 that can be used, although others can be used as well. In FIG. 10, a smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1Xrtt, and Short Message Service (SMS) signals. In some embodiments, phone 45 also includes a Secure Digital (SD) card slot 55 that accepts a SD card 57.

The mobile device of FIG. 11 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

Note that other forms of the devices 16 are possible.

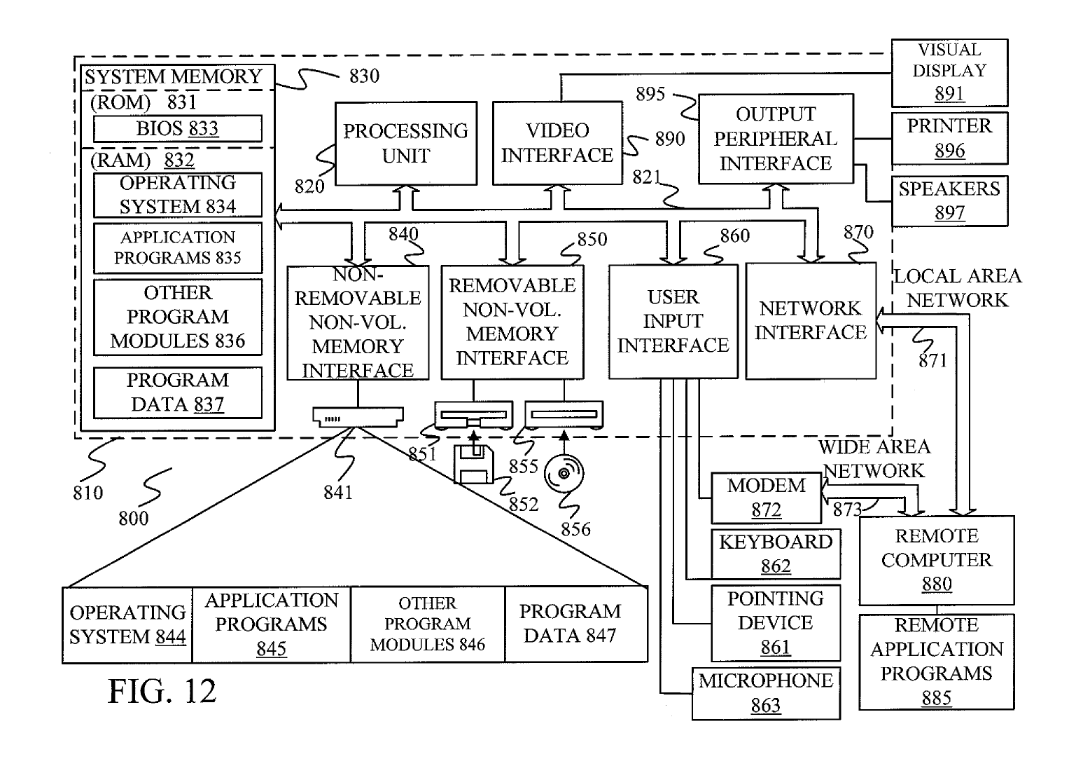

FIG. 12 is one embodiment of a computing environment in which system 100 (for example) can be deployed. With reference to FIG. 12, an exemplary system for implementing some embodiments includes a general-purpose computing device in the form of a computer 810. Components of computer 810 may include, but are not limited to, a processing unit 820 (which can comprise processor 106), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 10.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 12 illustrates operating system 834, application programs 835, other program modules 836, and program data 837.

The computer 810 may also include other removable/non-removable volatile/nonvolatile computer storage media. By way of example only, FIG. 12 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives and their associated computer storage media discussed above and illustrated in FIG. 12, provide storage of computer readable instructions, data structures, program modules and other data for the computer 810. In FIG. 12, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 12 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 12 illustrates remote application programs 885 as residing on remote computer 880. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-implemented method of delivering items defined in a contract for a project, comprising:
displaying, with a computer processor on a display device, a deliverable definition user interface (UI) display with first user input mechanisms and receiving deliverable inputs, through the first user input mechanisms., defining a deliverable that specifies terms of a service item to be delivered and invoiced as part of the project;
generating a mapping between a work plan, indicative of work to be performed to complete the deliverable, and the deliverable;
generating, with the computer processor, a progress UI display with second user input mechanisms and receiving progress inputs, through the second user input mechanisms, identifying progress toward completion of work in the work plan and calculating progress toward completion of the deliverable based on the progress inputs and the mapping;
displaying, with the computer processor, on a progress UI display, progress toward completion of the project, on a deliverable-by-deliverable basis, based on the calculated progress; and
automatically generating an invoice for the deliverable based on the progress toward completion of the deliverable.

2. The computer-implemented method of claim 1 and further comprising, after receiving deliverable inputs defining the deliverable:
generating a deliverable display that displays each deliverable defined by the deliverable inputs; and
displaying the deliverable display.

3. The computer-implemented method of claim 2 wherein displaying the deliverable display comprises:
displaying a textual indication of the deliverable, along with a corresponding start date and end date for the deliverable.

4. The computer-implemented method of claim 3 wherein displaying progress comprises:
updating the deliverable display based on the progress inputs.

5. The computer-implemented method of claim 4 wherein updating the deliverable display comprises:
updating the start date or end date corresponding to the deliverable based on the progress inputs.

6. The computer-implemented method of claim 5 wherein updating the start date or end date comprises:
determining whether the start date or end date is to be moved based on the progress inputs; and
displaying a visual indication that the start date or end date is to be moved to a new start date or a new end date.

7. The computer-implemented method of claim 4 wherein updating the deliverable display comprises:
comparing the progress inputs to the contract terms; and
displaying a visual warning indicator if the comparison of the progress inputs to the contract terms indicates that a contract term is not going to be met.

8. The computer-implemented method of claim 4 wherein displaying the deliverable display comprises:
displaying a corresponding number of effort units to complete the deliverable.

9. The computer-implemented method of claim 8 wherein receiving the progress inputs comprises:
receiving an update indicating a number of progress units expended against each deliverable.

10. The computer-implemented method of claim 9 wherein updating the deliverable display comprises:
comparing the number of progress units expended against each deliverable to a budgeted number of progress units corresponding to each deliverable; and
displaying a difference indicator indicating an amount of difference between the progress units expended against each deliverable and the budgeted number of progress units corresponding to each deliverable.

11. The computer-implemented method of claim 1 and further comprising:
calculating a measure of performance, based on a given performance metric and the mapping, corresponding to each deliverable; and
displaying a performance display, for each deliverable, indicative of the measure of performance corresponding to each deliverable.

12. The computer-implemented method of claim 11 wherein displaying a performance display comprises:
displaying profitability corresponding to each deliverable.

13. The computer-implemented method of claim 11 wherein displaying a performance display comprises:
displaying revenue corresponding to each deliverable.

14. The computer-implemented method of claim 11 wherein displaying a performance display comprises:
displaying cost corresponding to each deliverable.

15. The computer-implemented method of claim 11 wherein displaying a performance display comprises:
displaying earned value corresponding to each deliverable.

16. The computer-implemented method of claim 1 and further comprising, before generating the contract:
generating a proposal for a customer, the proposal including the deliverable; and
receiving customer approval of the proposal.

17. The computer-implemented method of claim 16 wherein generating the contract comprises:
importing the deliverable from the proposal approved by the customer into the contract; and
displaying the contract.

18. The computer-implemented method of claim 1 wherein receiving deliverable inputs comprises:
incorporating deliverable inputs received from the customer.

19. A project management system, comprising:
a deliverable definition component that generates a deliverable definition user interface display for receiving deliverable inputs defining deliverables to be delivered in fulfillment of a service contract;
a project management component, that generates a plan user interface display that receives plan inputs and generates a work definition, that is different from the deliverables, the work definition defining work done to deliver the deliverables, and the project management component generating a progress input display that receives progress inputs indicative of progress toward completion of the work, the project management component displaying the progress in terms of completing the deliverables;
a performance engine that calculates and displays a measure of performance, based on a given performance metric, corresponding to each deliverable; and
a processor that is a functional part of the system and activated by the deliverable definition component, the project management component and the performance engine to facilitate defining deliverables, displaying progress and displaying the measure of performance.

20. A computer readable storage medium storing computer readable instructions which, when executed by a computer, cause the computer to perform a method, comprising:
receiving deliverable inputs defining a deliverable that specifies terms of a service item to be delivered and invoiced as part of the project;
generating the contract including the deliverable;
receiving progress inputs identifying progress toward completion of the deliverable;
generating a deliverable display that displays each deliverable defined by the deliverable inputs;
displaying the deliverable display;
displaying progress toward completion of the project, on a deliverable-by-deliverable basis, based on the progress inputs;
updating the deliverable display based on the progress inputs;
calculating a measure of performance, based on a given performance metric, corresponding to each deliverable; and
displaying a performance display, for each deliverable, indicative of the measure of performance corresponding to each deliverable.
